(19) United States
(12) Patent Application Publication
(10) Pub. No.: US 2006/0218036 A1
(43) Pub. Date: Sep. 28, 2006

(54) System and method for embedding dynamic, server-based questionnaire content within online banner ads

(76) Inventors: Michael Devin King, La Jolla, CA (US); Andreas Rudolf Sheriff, Vista, CA (US); Roy Harrison DiBenerdini, San Diego, CA (US)

Correspondence Address: PETER K HAHN;LUCE, FORWARD, HAMILTON, SCRIPPS, LLP., 600 WEST BROADWAY, SUITE 2600, SAN DIEGO, CA, 92101, US

(21) Appl. No.: 11/088,581

(22) Filed: Mar. 23, 2005

(51) Int. Cl. G06Q 30/00; G07G 1/00

(52) U.S. Cl. 705/14; 705/10

(57) ABSTRACT

The present invention is directed to a system and method for serving questionnaire content within a banner ad, the system including a web server, a web browser that requests and receives a web page including the banner ad from the web server and a questionnaire server for serving the questionnaire content. The banner ad requests and receives a Flash program for displaying questionnaire content received from the questionnaire server, the questionnaire content comprising multi-page, dynamic questionnaire content that allows users to interact with the banner ad without clicking-through to the questionnaire.

### FIELD OF THE INVENTION

The present invention generally relates to Internet advertisement, and more particularly to Internet advertisement wherein dynamic, server-based questionnaire content is embedded within a banner ad.

### BACKGROUND OF THE INVENTION

Internet advertising continues to grow at a torrid pace. One of the most prominent forms of Internet advertising is the online banner ad. Online banner ads are inserted within a web page for displaying an advertiser's images, messages and invitations such that a user may “click-through” to access additional content provided by the advertiser. The ability to click-through provides consumers with instant access to information about a product and provides advertisers with access to active and engaged consumers.

Conventional banner ads suffer from a number of known drawbacks. One such drawback is that consumers often are reluctant to click on banner ads even if they are interested in the product. One cause for this reluctance is that clicking on the banner ad will take the user away from the current web page. Another drawback of conventional banner ads is that the advertiser may not want all consumers to click-through to access additional content. Instead, the advertiser may only desire consumers that match a particular demographic.

In view of the above drawbacks, there exists a need for a system and method for embedding a questionnaire within a banner ad that permits a user to interact with the questionnaire without clicking-through.

There further exists a need for a server-based system and method for embedding a questionnaire within a banner ad that is adapted to present and collect data from the banner ad interaction as it occurs.

There also exists a need for a system and method for embedding a questionnaire within a banner ad, wherein a user is more likely to interact with the banner ad.

There additionally exists a need for a system and method for embedding a questionnaire within a banner ad, wherein an advertiser is able to collect data without redirecting users, or only redirecting users under certain circumstances.

### SUMMARY OF THE INVENTION

In view of the foregoing, it is an object of the present invention to provide a system and method for embedding a questionnaire within a banner ad that permits a user to interact with the questionnaire without clicking-through.

It is a further object of the present invention to provide a server-based system and method for embedding a questionnaire within a banner ad that is adapted to present and collect data from the banner ad interaction as it occurs.

It is an additional object of the present invention to provide a system and method for embedding a questionnaire within a banner ad, wherein a user is more likely to interact with the banner ad.

It is an additional object of the present invention to provide a system and method for embedding a questionnaire within a banner ad, wherein an advertiser is able to collect data without redirecting users, or only redirecting users under certain circumstances.

The present invention is directed to a system and method for serving questionnaire content within a banner ad, the system including a web server, a web browser that requests and receives a web page including the banner ad from the web server and a questionnaire server for serving the questionnaire content. The banner ad requests and receives a Flash program for displaying questionnaire content received from the questionnaire server, the questionnaire content comprising multi-page, dynamic questionnaire content that allows users to interact with the banner ad without clicking-through to the questionnaire.

According to one embodiment of the present invention, embedded questionnaire functionality is implemented by sequentially loading pages of Flash content from a questionnaire server into the banner ad. The questionnaire server generates each page of content dynamically as a Flash File Format (SWF) program. The SWF program preferably contains presentation data for one questionnaire page and code to collect the questionnaire input from that page and send it back to the questionnaire server. This embodiment is referred to herein as the “dynamic SWF” embodiment or the “dynamic SWF system” of the invention.

The process begins when a Flash movie embedded in the banner ad requests a page of questionnaire content from the questionnaire server. The server produces a dynamic SWF program for the page and sends it to the Flash movie. The Flash movie receives and loads the SWF program, which renders the page and activates a data collection mechanism for the page. The SWF program collects user input, encodes the input data in URL format, and sends the input back to the server. The questionnaire server receives and processes this data and dynamically generates the next page as a SWF program. The Flash movie receives and loads the next page, thereby replacing the previous page. The process continues until the last page of the questionnaire is displayed.

According to another embodiment of the invention, questionnaire functionality is implemented by embedding a Flash client program into the banner ad. The Flash client program remains resident in the banner ad and mediates the questionnaire process. The questionnaire server preferably generates each page of presentation content dynamically as XML. This embodiment is referred to herein as the “dynamic XML” embodiment or the “dynamic SWF system” of the invention.

The process begins when a Flash movie embedded in the banner ad requests the Flash client program from the server. The Flash movie loads the Flash client program, and the Flash client program requests the first page of questionnaire content from the server, which produces the dynamic XML content for the page and sends it to the Flash client. The Flash client receives the content, parses it, and renders the questionnaire presentation. The Flash client preferably collects user input, encodes it in XML, and sends the input back to the server, which receives and processes the input, and generates the next page of dynamic XML. The Flash client program receives the XML, parses it, and renders the next page, thereby replacing the previous content. The process continues until the last page of the questionnaire is displayed.

### BRIEF DESCRIPTION OF THE DRAWINGS

Further features of the invention, its nature and various advantages will be more apparent from the accompanying drawings and the following detailed description of the preferred embodiments, in which:

FIG. 1 (prior art) depicts a conventional banner ad having static content;

FIG. 2 depicts a banner ad having dynamic questionnaire content designed in accordance with the principles of the present invention;

FIG. 3 is a schematic diagram showing a website system for serving questionnaire content within a banner ad according to the present invention;

FIG. 4 is a schematic diagram depicting an ad-server system for serving questionnaire content within a banner ad according to the present invention;

FIG. 5 is a schematic diagram depicting data flow in a dynamic SWF embodiment of the present invention;

FIG. 6 is a schematic diagram depicting components of the dynamic SWF embodiment of the present invention;

FIG. 7 is a schematic diagram depicting data flow in a dynamic XML embodiment of the invention; and

FIG. 8 is a schematic diagram depicting components of the dynamic XML system of the present invention.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides a website system for serving questionnaire content within a banner ad. Advantageously, an embedded questionnaire designed according to the principles of the invention allows a user to interact with the banner ad without requiring the user to click-through to the questionnaire. The system is designed to increase the likelihood that a user will interact with a banner ad. The system also allows advertisers to present advertising and research content in the same banner ad.

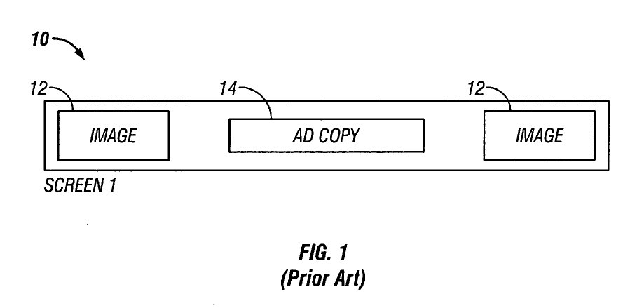

Referring to FIG. 1 (prior art), a conventional banner ad 10 having static content is depicted. Banner ad 10 includes a single screen (Screen 1) comprising a combination of image content 12 and text content 14 in a predefined size format. The only user interaction involves the standard click-through action of the entire banner ad. Other conventional banner ads may contain an image that looks like questionnaire content. However, the image is not a real questionnaire.

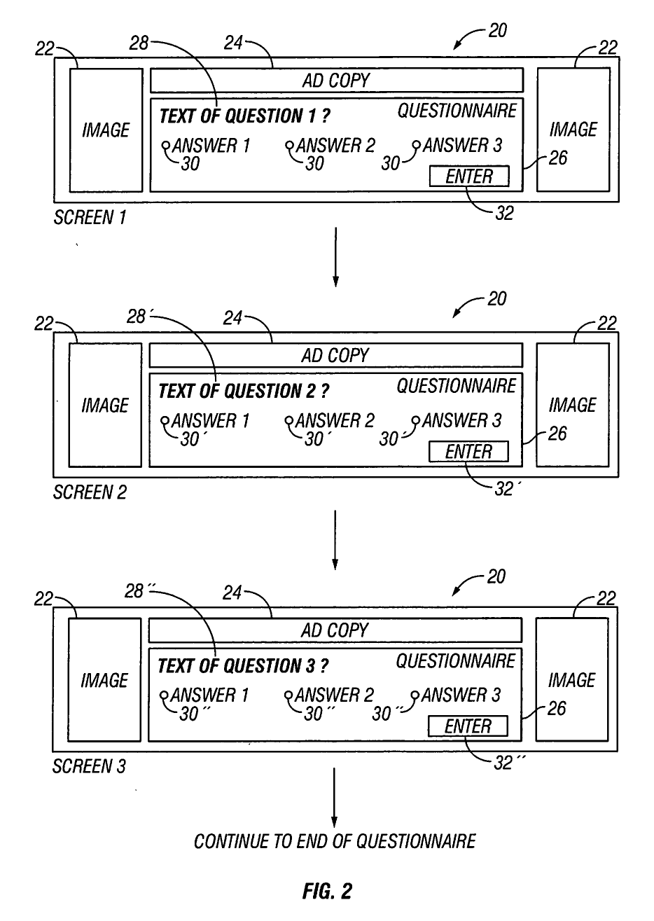

Referring to FIG. 2, a banner ad 20 designed in accordance with the principles of the present invention is shown. Banner ad 20 includes image content 22, text content 24 and an embedded, dynamic, multi-page questionnaire 26. Initially, a user is presented with Screen 1, which contains the text 28 of a first question. The user responds to the first question by clicking on an appropriate input object 30 corresponding to the selected answer, and then clicking on enter button 32. The user is then presented with Screen 2 containing the text 28′ of a second question, a plurality of potential answers 30′ and enter button 32′. The process is repeated until the last screen of multi-page questionnaire 26 is displayed. The content of questionnaire 26 may include text, graphics, multimedia, input widgets and other conventional questionnaire content.

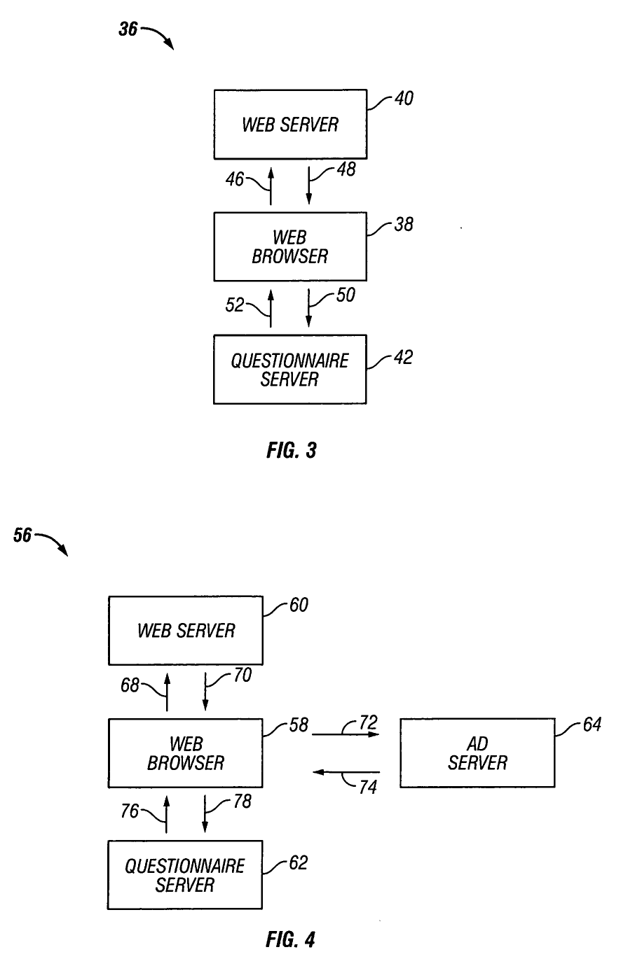

According to an aspect of the invention, the questionnaire may be embedded in the banner ad of an existing system. Referring to FIG. 3, a website system 36 for serving questionnaire content within banner ads comprises web browser 38, web server 40 and questionnaire server 42. In the illustrated embodiment, the web page content and banner ad content are served from a single Internet domain. The questionnaire content may be served from the same Internet domain as the banner ad content, or alternatively, from any other appropriate domain. Referring to step 46, web browser 38 initially requests a web page and banner ad from web server 40. In step 48, web browser 38 receives the web page and banner ad from web server 40. In step 50, the banner ad within web browser 38 requests a Flash program for displaying the questionnaire from questionnaire server 42. In step 52, the banner ad receives the Flash program for displaying the questionnaire from questionnaire server 42.

Referring to FIG. 4, an ad-server system 56 for serving questionnaire content within banner ads comprises web browser 58, web server 60, questionnaire server 62 and ad server 64. In the illustrated embodiment, web page content is served from a first Internet domain, ad-server content is served from a second Internet domain, and questionnaire content is served from a third Internet domain. Referring to step 68, web browser 58 initially requests a web page from web server 60. In step 70, web browser 58 receives the web page from web server 60. In step 72, the web page within web browser 58 requests a banner ad from ad server 64. In step 74, the web page receives the banner ad from ad server 64. In step 76, the banner ad requests a Flash program from questionnaire server 62 for displaying the questionnaire. In step 78, the banner ad receives the Flash program from questionnaire server 62 for displaying the questionnaire.

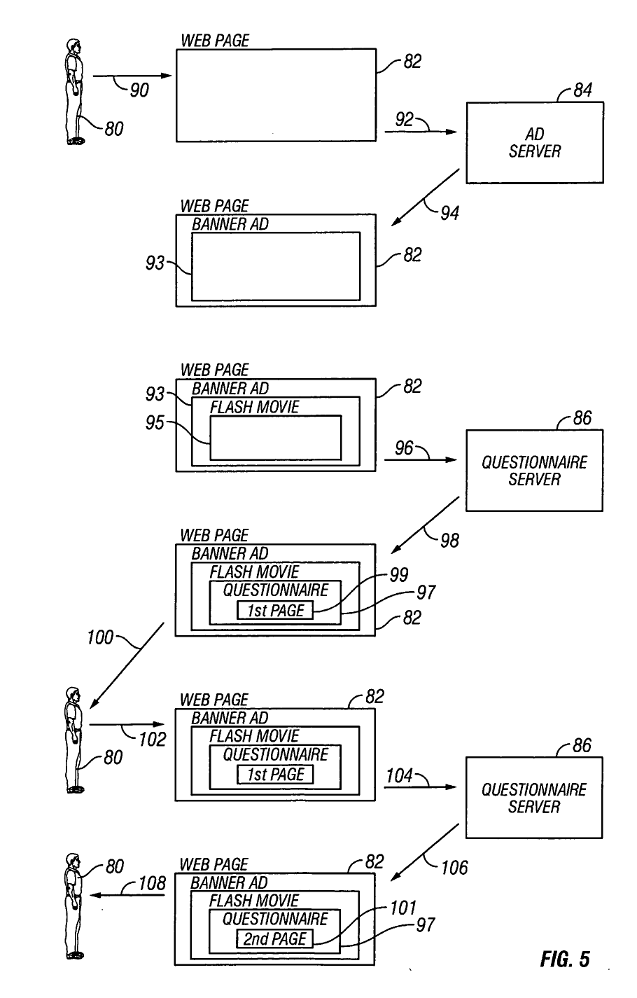

Referring to FIG. 5, the preferred embodiment of the invention features a dynamic SWF system, wherein embedded questionnaire functionality is implemented by sequentially loading pages of Flash content from the questionnaire server into the banner ad. Specifically, data flow is shown among user 80, web page 82 (displayed on a client computer), ad server 84 and questionnaire server 86. Referring to step 90, user 80 initially opens a web browser and requests web page 82. In step 92, the web browser loads the web page 82 and requests an embedded banner ad 93 from ad server 84. In step 94, ad server 84 retrieves banner ad 93 and sends it to web page 82. Referring to step 96, web page 82 loads banner ad 93 containing embedded Flash movie 95, which requests first page 97 of questionnaire 99 from questionnaire server 86. In step 98, questionnaire server 86 dynamically generates first page 97 of questionnaire 99 as an SWF program and sends it to Flash movie 95 within banner ad 93.

Referring to step 100, Flash movie 93 loads the first page 97 of questionnaire 99, renders the dynamic content as an SWF program and activates code to collect user input. In step 102, user 80 interacts with web page 82 by responding to questions of questionnaire 97. In step 104, Flash movie 95 gathers the user input, converts it to URL-encoded format, and sends it to questionnaire server 86. Referring to step 106, questionnaire server 86 processes and stores the input and dynamically generates the second page 101 of questionnaire 97 as an SWF program. In step 108, Flash movie 95 loads the new SWF program (second page 101), thereby replacing the previous SWF program (first page 99). The process is repeated until the last page of questionnaire 97 is displayed.

One advantage of the dynamic SWF system described hereinabove is that the system preferably is capable of working within existing systems for serving online banner ads. A further advantage is that survey data content preferably is small enough to download over dial-up connections. Yet another advantage is that the surveys preferably are able to play in Macromedia Flash Player Version 4 and up. As would be appreciated by those of ordinary skill in the art, the dynamic SWF, system may be designed to play in many other computer programs without departing from the scope of the present invention.

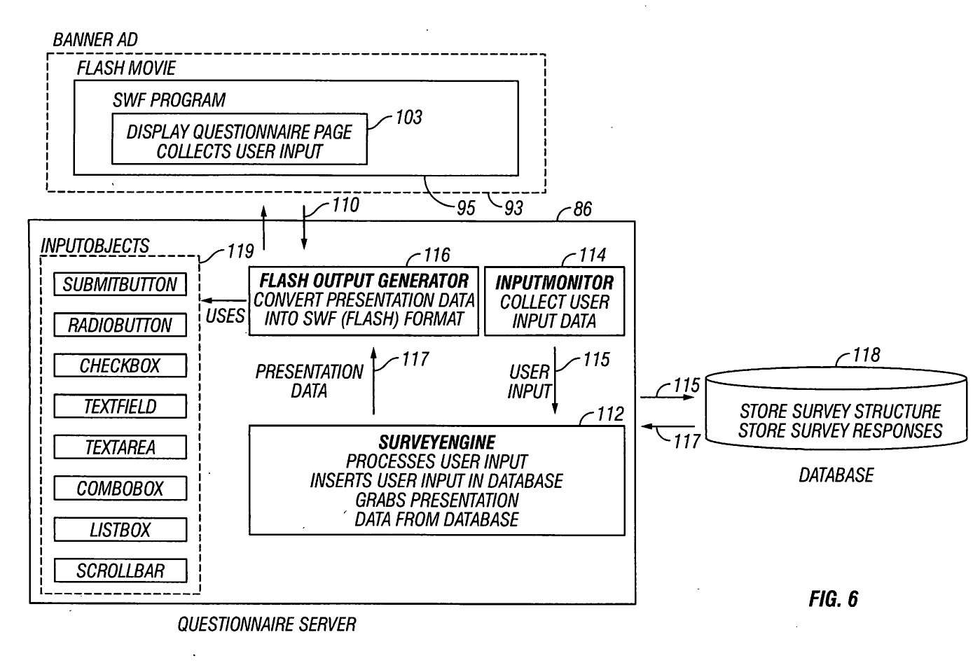

FIG. 6 is a schematic diagram depicting components of the dynamic SWF system of the present invention. In the illustrated embodiment, Flash movie 95 is embedded within banner ad 93. According to a preferred implementation, Flash movie 95 is compiled to work with Flash 4 and up. Flash movie 95 loads an SWF program 103 from questionnaire server 86, the SWF program comprising data corresponding to a page (e.g., first page 99) of the questionnaire. In operation, SWF program 103 displays the content of page 99, collects user input and sends the input to questionnaire server 86 in the form of URL-encoded data 110. This process is then repeated for each page of content of the questionnaire.

Questionnaire server 86 preferably is an online survey system that allows dynamic interactions with questionnaires in banner ads. Questionnaire server 86 comprises survey engine 112, input monitor 114 and Flash output generator 116. Questionnaire content and responses preferably are stored in server-side database 118. Input monitor 114 collects user input 115, converts the user input to a response object and sends it to survey engine 112. Survey engine 112 processes user input 115, inserts the input in database 118 and retrieves pages of presentation data 117 from database 118. Flash output generator 116 converts each page of presentation data 117 from server-side database 118 into an SWF program and sends the program to Flash movie 95 embedded in banner ad 93. Flash output generator 116 may utilize input objects 119 such as standard questionnaire input widgets that have been designed to download quickly over the Internet including, but not limited to: submit buttons, radio buttons, check boxes, text fields, text areas, combination boxes, list boxes and scroll bars.

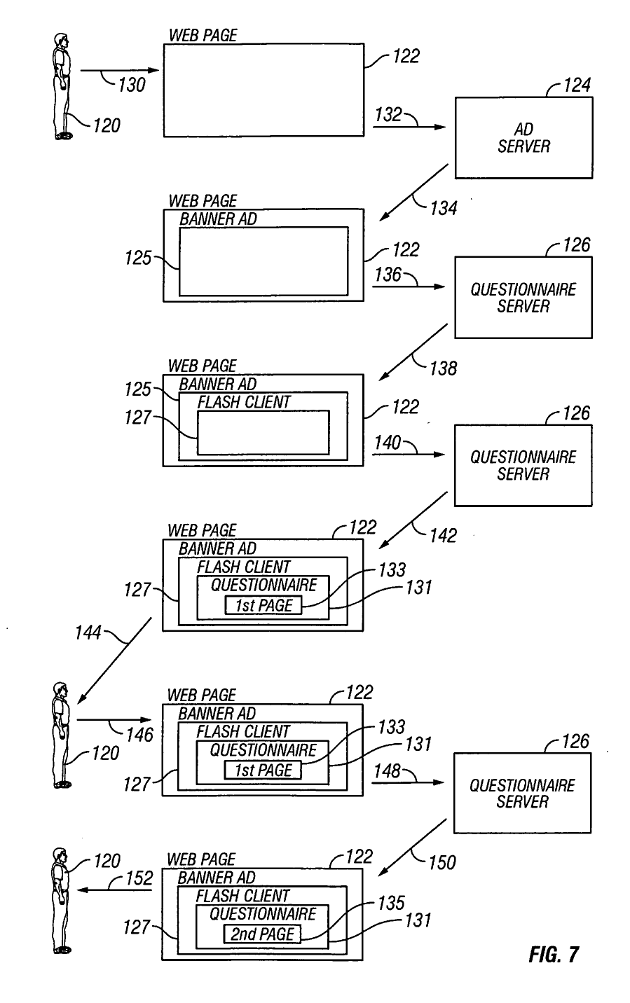

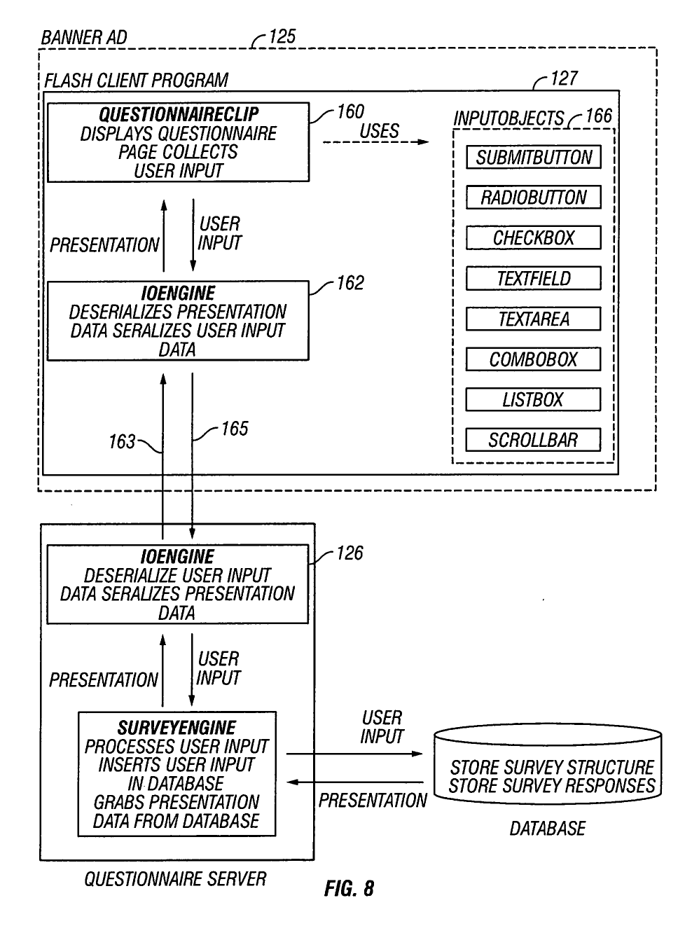

FIG. 7 is a schematic diagram of an alternative embodiment of the present invention featuring a dynamic XML system, wherein a Flash client program is embedded within the banner ad. Similar to the embodiment of FIG. 5, data flow is shown among user 120, web page 122 (displayed on a client computer), ad server 124 and questionnaire server 126. Referring to step 130, user 120 initially opens a web browser and requests web page 122. In step 132, the web browser loads the web page 122 and requests an embedded banner ad 125 from ad server 124. In step 134, ad server 124 retrieves banner ad 125 and sends it to web page 122. Referring to step 136, web page 122 loads banner ad 125 containing an embedded Flash movie, which requests Flash client program 127 from questionnaire server 126. In step 138, questionnaire server 126 retrieves Flash client program 127 and sends it to banner ad 125.

Referring to step 140, the banner ad 125 loads Flash client program 127, which requests first page 133 of questionnaire 131 from questionnaire server 126. In step 142, questionnaire server 126 dynamically generates first page 133 of questionnaire 131, encodes the data in an XML format, and sends it to Flash client program 127. In step 144, Flash client program 127 receives and parses the XML, and renders the content of first page 133 for user 120 to view within banner ad 125. In step 146, user 120 interacts with web page 122 by responding to questions of questionnaire 131. Referring to step 148, Flash client program 127 gathers the user input, serializes it in XML, and sends it to questionnaire server 126. In step 150, questionnaire server 126 processes and stores the input and dynamically generates second page 135 of XML content. In step 152, Flash client program 127 loads the new XML content, parses it, and renders the second page of content. The process is repeated until the last page of questionnaire 131 is displayed.

Similar to the dynamic SWF system, the dynamic XML system preferably is: (1) capable of working within existing systems for serving online banner ads; (2) small enough to download over dial-up connections; and (3) able to play in Macromedia Flash Player Version 4 and up. As would be appreciated by those of ordinary skill in the art, the dynamic XML system may be designed to play in many other computer programs without departing from the scope of the present invention.

FIG.. 8 is a schematic diagram depicting components of the dynamic XML system of the present invention. In the illustrated embodiment, Flash client program 127 is embedded within banner ad 125 such that it controls the questionnaire functionality within the banner ad. Flash client program 127 comprises questionnaire clip 160, input/output engine 162, and a set of input objects 166. questionnaire clip 160 displays the content of the questionnaire page, collects user input and sends the input to input/output engine 162. Input/output engine 162 deserializes presentation data 163 (from XML) received from questionnaire server 126 (over tcp/ip) and serializes user input data 165 (to XML) that is sent (over tcp/ip) to questionnaire server 126. Questionnaire clip 160 may utilize input objects 166 such as standard questionnaire input widgets that have been designed to download quickly over the Internet including, but not limited to: submit buttons, radio buttons, check boxes, text fields, text areas, combination boxes, list boxes and scroll bars.

In operation, Flash client program 127 receives a page of XML presentation data from questionnaire server 126, deserializes the data into a Flash object, and renders the presentation to banner ad 125 using any input objects 166 necessary for the page. The input objects 166 then receive input actions from the user such that when the user clicks the submit button, the questionnaire clip collects the input in a response object and sends the object to input/output engine 162 where it is serialized to XML and sent to questionnaire server 126.

Questionnaire server 126 preferably is an online survey system that allows dynamic interactions with questionnaires in banner ads. Questionnaire server 126 comprises survey engine 172 and input/output engine 174. Questionnaire content and responses preferably are stored in server-side database 178. Input/output engine 172 deserializes user input from XML into a response object and serializes presentation data into an XML format. Survey engine 172 processes user input 115 received from input/output engine 172, inserts the input in database 178 and retrieves presentation data from database 118.

Thus, it is seen that a system and method for embedding a questionnaire in a banner ad is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. It is noted that various equivalents for the particular embodiments discussed in this description may practice the invention as well.

While the described embodiments involve sending a single page of questionnaire content to the client at a time, it is possible that the system could send all pages of questionnaire content to the client simultaneously, and then have the client present the pages in the proper order. Further, the client could collect all of the responses and wait until the end of the survey to send them to the questionnaire server. Additionally, although the Flash client program of the invention presents the embedded content in a web browser on a PC, it will be understood to those of ordinary skill in the art that the content alternatively may be embedded and presented within a cellular phone or PDA without departing from the scope of the invention.

What is claimed is:

1. A system for serving questionnaire content within a banner ad, comprising:
a web server;
a web browser that requests and receives a web page including the banner ad from the web server; and
a questionnaire server for serving the questionnaire content;
wherein the banner ad requests and receives a Flash program for displaying questionnaire content received from the questionnaire server.

2. The system of claim 1, wherein the questionnaire content comprises multi-page, dynamic questionnaire content, which:
allows a user to interact with the banner ad without requiring the user to click-through to the questionnaire; and
allows advertisers to present both advertising content and research content in the same web space.

3. The system of claim 1, wherein web page content and banner ad content are served from a single Internet domain.

4. The system of claim 1, wherein the questionnaire server is an online survey system that allows dynamic interactions with the questionnaire content, wherein the questionnaire server comprises a survey engine, an input monitor and a Flash output generator.

5. The system of claim 4, wherein the input monitor collects user input, converts the user input into a response object and sends the user input to the survey engine.

6. The system of claim 5, wherein the survey engine processes the user input, inserts the user input in a database and retrieves pages of presentation data from the database.

7. The system of claim 6, wherein the Flash output generator converts each page of presentation data from the database into an SWF program and sends the program to the Flash program embedded in the banner ad.

8. An system for serving questionnaire content within a banner ad, comprising:
a web server;
a web browser that requests and receives a web page from the web server;
a questionnaire server for serving the questionnaire content; and
an ad server;
wherein the web page requests and receives the banner ad from the ad server;
wherein the banner ad requests and receives a Flash program from the questionnaire server for displaying the questionnaire content.

9. The system of claim 8, wherein the questionnaire content is multi-page, dynamic questionnaire content, which:
allows a user to interact with the banner ad without requiring the user to click-through to the questionnaire; and
allows advertisers to present advertising and research content- in the same web space.

10. The system of claim 8, wherein web page content is served from a first Internet domain, ad-server content is served from a second Internet domain, and questionnaire content is served from a third Internet domain.

11. The system of claim 8, wherein embedded questionnaire functionality is implemented by sequentially loading pages of Flash content from the questionnaire server into the banner ad.

12. The system of claim 8, wherein the questionnaire server dynamically generates a first page of questionnaire content, encodes the data in an XML format, and sends the data to the Flash program.

13. The system of claim 12, wherein the Flash program gathers user input, serializes the user input in XML format and sends the resulting data to the questionnaire server.

14. The system of claim 8, wherein the Flash program comprises:
a questionnaire clip that displays the content of a questionnaire page and collects user input;
an input/output engine that deserializes presentation data received from the questionnaire server and serializes user input data that is sent to the questionnaire server.

15. A method of serving questionnaire content within a banner ad, the method comprising:
loading a web page; and
requesting the banner ad from a first server, the banner ad containing an embedded Flash movie;
wherein the Flash movie requests a first page of questionnaire content from a second server.

16. The method of claim 15, wherein the first server is an ad server and the second server is a questionnaire server.

17. The method of claim 15, wherein the questionnaire server dynamically generates the first page of questionnaire content as an SWF program and sends it to the Flash movie.

18. The method of claim 17, wherein the Flash movie loads the first page of questionnaire content, renders the questionnaire content as an SWF program and activates a code to collect user input.

19. The method of claim 18,.wherein the Flash movie gathers user input, converts the user input to URL-encoded format and sends the user input to the questionnaire server.

20. The method of claim 19, wherein the questionnaire server processes and stores the user input and dynamically generates the second page of questionnaire content as an SWF program.
